(19) United States
(12) Patent Application Publication
(10) Pub. No.: US 2008/0294653 A1
(43) Pub. Date: Nov. 27, 2008

(54) CONDITION BASED SCHEMA EVALUATION

(76) Inventors: Yogesh Vilas Golwalkar, Gwalior (IN); Magesh Rajamani, Tirunelveli (IN)

Correspondence Address: IBM CORP (YA);C/O YEE & ASSOCIATES PC, P.O. BOX 802333, DALLAS, TX, 75380, US

(21) Appl. No.: 11/752,757

(22) Filed: May 23, 2007

(51) Int. Cl. G06F 17/00

(52) U.S. Cl. 707/100

(57) ABSTRACT

The illustrative embodiments described herein provide a computer implemented method, apparatus, and computer program product for defining a condition based schema for a directory on a directory server. A schema is defined based on a protocol for querying directory services on a directory server. A conditional statement is added to the schema. Responsive to a determination that a first set of attributes within the conditional statement is evaluated to be true, requiring a value for a second set of attributes within the schema to be present in an entry. The conditional statement is enforced by the server rather than by an application accessing the directory.

### BACKGROUND OF THE INVENTION

1. Field of the Invention

The present invention relates generally to an improved data processing system and in particular to a method and apparatus for defining a schema. Still more particularly, the present invention relates to a computer implemented method, apparatus, and computer program product for providing a condition based schema in a directory server.

2. Description of the Related Art

A directory service is a central point where network services, security services, and applications can form an integrated distributed computing environment. Typical uses of a directory service may be classified into several categories. A “naming service”, such as Directory Naming Service (DNS) or Cell Directory Service (CDS), uses the directory as a source to locate an Internet Host address or the location of a given server. A “user registry”, such as Novell Directory Services (NDS), stores information about users in a system comprised of a number of interconnected machines. Still another directory service is a “white pages” lookup provided by some mail clients, such as Netscape Communicator or Lotus Notes.

Lightweight Directory Access Protocol (LDAP) is a software protocol for providing directory service enablement to a large number of applications. These applications range from e-mail to distributed system management tools. LDAP is an evolving protocol model based on the client-server model in which a client makes a transmission control protocol/Internet protocol (TCP/IP) connection to an LDAP server. LDAP is a “lightweight” version of Directory Access Protocol (DAP), which is part of X.500, a standard for directory services in a network.

In general, directory services provide methods for storing, modifying and querying data in a directory on a directory server in a standards-defined manner. In order to meet these standards, schemas have been defined by the International Engineering Task Force (IETF). A schema is a template for representing a class of data. A server uses the schema to determine how to match a filter or attribute value (in a compare operation) against the attributes of an entry to permit add operations and modify operations.

A directory schema specifies the types of objects that a directory may have and the mandatory and optional attributes of each object type. Every object is termed as an entry in the directory. Entries are typically organized in a specified tree structure, and each entry is composed of attributes and corresponding values. Objectclass is a special attribute which every entry must have. The attributes that an entry can be comprise of is determined by the objectclass attribute. This information is referred to as the schema for that objectclass entry.

Currently, an objectclass schema indicates the MUST and MAY attribute which an objectclass entry can have. An attribute having a MUST identifier, also referred to as a “required” attribute, is required to be present in the entry. An attribute having the MAY identifier, also referred to as a “may have” attribute, may or may not appear in the entry. In other words, an attribute associated with a MAY attribute is not required to be present in the entry. Thus, the existence of an attribute in an entry is non-dependent on the value of any other attribute in the entry.

### SUMMARY OF THE INVENTION

The illustrative embodiments described herein provide a computer implemented method, apparatus, and computer program product for defining a condition based schema for a directory on a directory server. A schema is defined based on a protocol for querying directory services on a directory server. A conditional statement is added to the schema. Responsive to a determination that a first set of attributes within the conditional statement is evaluated to be true, requiring a value for a second set of attributes within the schema to be present in an entry. The conditional statement is enforced by the server rather than by an application accessing the directory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is an exemplary block diagram of the primary operational components of a directory server in accordance with an illustrative embodiment;

FIG. 4 is an exemplary diagram of a typical objectclass schema;

FIG. 5 is an exemplary diagram of a schema in accordance with an illustrative embodiment;

FIG. 6 is another exemplary diagram of a schema in accordance with an illustrative embodiment;

FIG. 7 is another exemplary diagram of a schema in accordance with an illustrative embodiment; and

FIG. 8 is a flowchart outlining an exemplary operation for performing schema validation in accordance with an illustrative embodiment.

### DETAILED DESCRIPTION OF THE PREFERRED EMBODIMENT

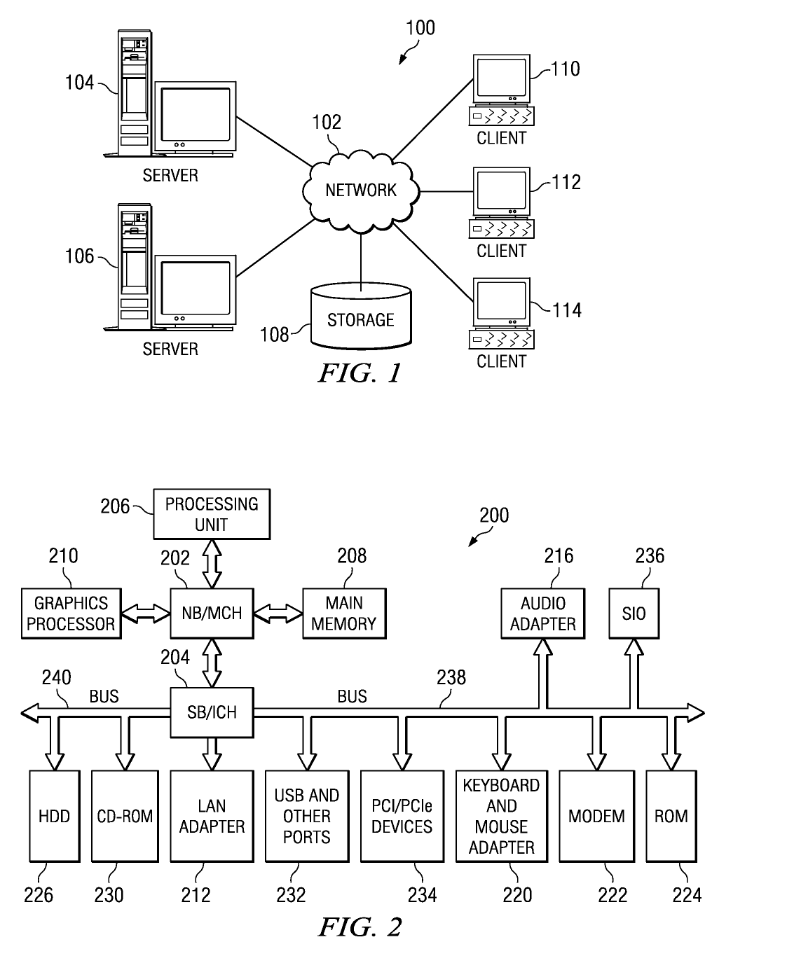

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Furthermore, server 104 and server 106 may provide directory services to clients 110, 112, and 114. Network data processing system 100 may include additional servers, clients, and other devices not shown.

Network 102 may be, without limitation, a local area network (LAN), wide area network (WAN), Internet, Ethernet, or Intranet. In this example, network 102 is the Internet, representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer implemented method, apparatus, and computer program product for defining a condition based schema for a directory on a directory server. A schema is defined based on a protocol for querying directory services on a directory server. A conditional statement is added to the schema. Responsive to a determination that a first set of attributes within the conditional statement is evaluated to be true, requiring a value for a second set of attributes within the schema to be present in an entry. The conditional statement is enforced by the server rather than by an application accessing the directory.

A condition based schema is a schema in which particular “MAY” attributes of an objectclass entry become “MUST” attributes of the objectclass entry. A conditional statement is added to the schema. The first part of the conditional statement is the condition to be evaluated. The second part of the conditional statement contains “MAY” attributes of the objectclass entry. If the condition in the first part of the conditional statement is evaluated to be true, the “MAY” attributes listed in the second part of the conditional statement become “MUST” attributes of the objectclass entry. Thus, the requirement of certain “MAY” attributes are based upon a condition being evaluated as true in a condition based schema.

Enforcement by the server means that the server will validate the entry to determine the entry's validity. If the server determines that the entry is valid and the conditioned in the first part of the conditional statement is evaluated to be true then the second set of attributes become “MUST” attributes for the entry. Otherwise, the server will return an objectclass violation.

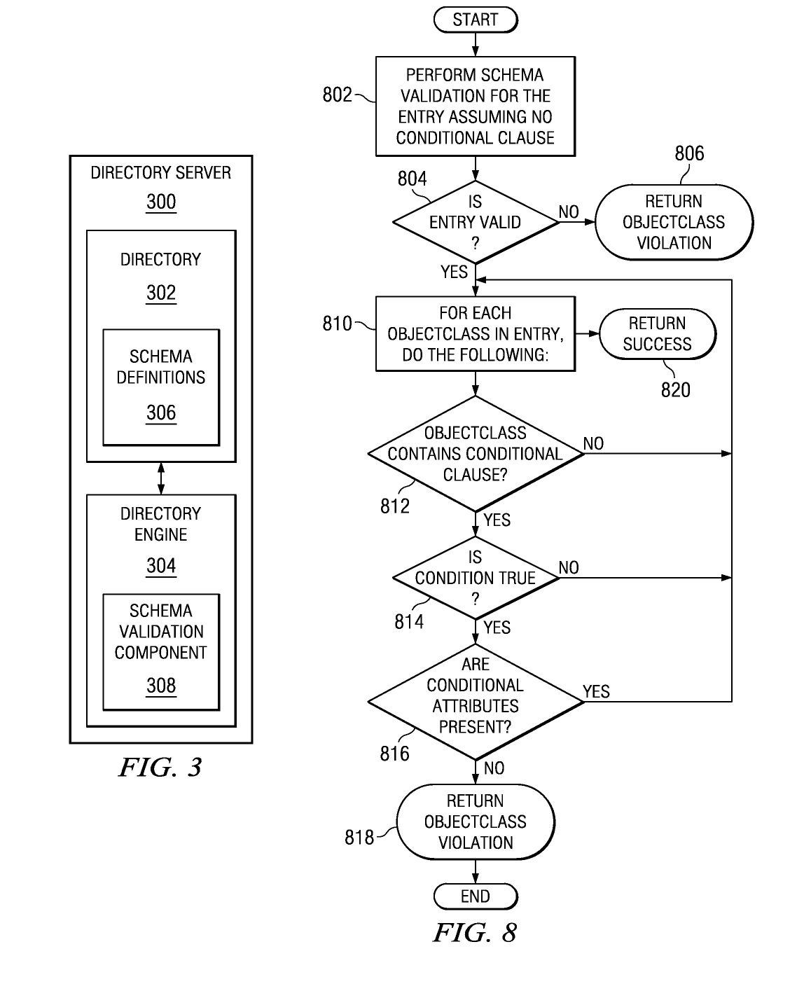

FIG. 3 is a block diagram of the primary operational components of a directory server in accordance with an illustrative embodiment. As shown in FIG. 3, directory server 300 includes directory 302.

Directory server 300 may be implemented in any type of server, such as server 104 in FIG. 1. Directory server 300 may be any type of directory server including, but not limited, to an IBM Tivoli Directory Server, Sun Java System Directory Server, Apache Directory server, and Red Hat Directory Server.

Directory 302 may contain any type of data including, but not limited to, address books, configuration data, and user authentication. In this illustrative embodiment, directory 302 includes schema definition file 306 stored in memory. Schema definition file 306 contains the schema definitions for each object in directory 302 Schema definition file 306 specifies the types of objects that directory 302 may have and the mandatory and optional attributes of each object type.

Directory server 300 also includes directory engine 304 for querying directory 302. In this illustrative embodiment, directory engine 304 includes schema validation component 308. Schema validation component 308 validates requests from a client, such as a client 110 in FIG. 1, for storing, modifying and querying data in directory 302.

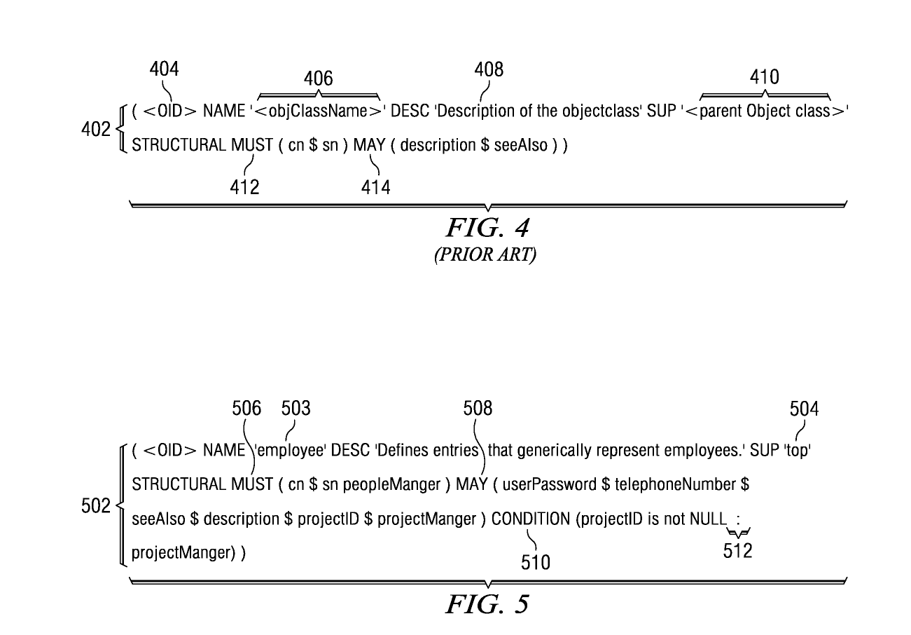

FIG. 4 is an exemplary diagram of a typical objectclass schema. Objectclass schema 402 begins with object identifier number 404, <OID>, followed by a textual name of the objectclass, <objClassName> 406. Description 408 of objClassName 406 is then presented.

An important part of the schema is the SUP ‘<parent Objectclass>’ 410 string. This part of the schema states that objClassName 406 inherits its attributes from the superior class, ‘<parent Object class>’ 410. Therefore, an objClassName 406 entry must have all the required attributes of the superior class, ‘<parent Object class>’ 410.

Following the SUP string, the schema defines the MUST and MAY attributes of objClassName 406. An attribute with the identifier MUST is required to be present in the entry. An attribute with the identifier MAY, may or may not appear in the entry. The “$” character is used as a separator between attributes. Objectclass schema 402 includes MUST attributes 412 and MAY attributes 414. MUST attributes 412 include attributes cn (common name) and sn (surname). Thus, attributes cn and sn must be present in an objClassName 406 entry. MAY attributes 414 include attributes description and seeAlso. Therefore, attributes description and seeAlso may or may not be in an objClassName 406 entry.

Thus, objectclass schema 402 shows that the existence of an attribute in an objClassName 406 entry is solely dependent on the MAY or MUST classification. The existence of an attribute in an objClassName 406 entry is not dependent on any other attribute in the entry or its value.

With reference to FIG. 5, an exemplary diagram of an objectclass schema is illustrated in accordance with an illustrative embodiment. Objectclass schema 502 defines employee objectclass 503. Employee objectclass 503 does not inherit attributes from a superior class because its superior class is the special abstract class ‘top’ 504. Employee objectclass 503 includes MUST attributes 506 and MAY attributes 508. MUST attributes 506 include cn, sn, and peopleManager. MAY attributes 508 include userPassword, telephoneNumber, seeAlso, description, projectID, and projectManger. Based on the above described employee schema, an employee objectclass 503 entry may have a projectID attribute and not have a projectManger attribute.

However, if a project manager is required to be assigned to every employee that is assigned a project, objectclass schema 502 includes conditional statement 510. Conditional statement 510 states that if the projectID is not NULL then the projectManger attribute is required. In other words, if the condition before colon 512 is determined to be true, then the attributes following colon 512 become “MUST” attributes for an employee objectclass 503 entry. If the condition before colon 512 is determined to be false, the attributes following colon 512 remain “MAY” attributes for an employee objectclass 503 entry.

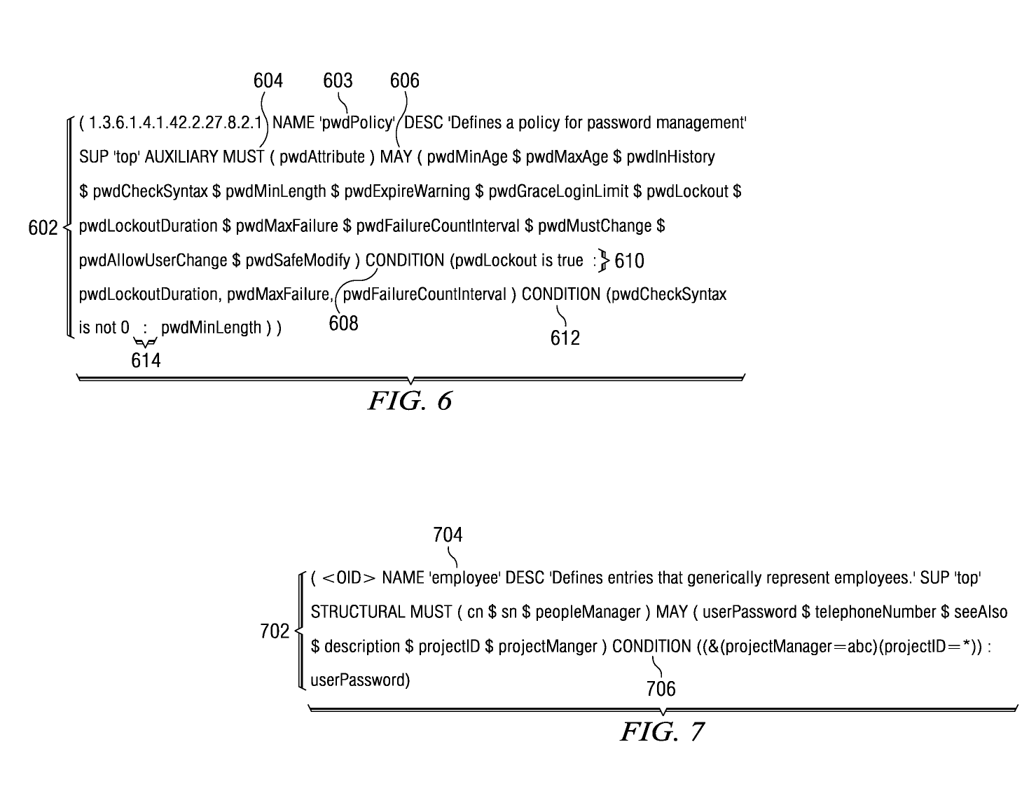

With reference to FIG. 6, another exemplary diagram of an objectclass schema is illustrated in accordance with an illustrative embodiment. Objectclass schema 602 defines pwdPolicy objectclass 603. pwdPolicy objectclass 603 contains MUST attribute 604 and MAY attributes 606. MUST attribute 604 includes pwdAttribute. pwdAttribute holds the name of the attribute to which the password policy is applied. For example, the password policy may be applied to the userPassword attribute. MAY attributes 606 includes the following attributes: pwdMinAge, pwdMaxAge, pwdInHistory, pwdCheckSyntax, pwdMinLength, pwdExpireWarning, pwdGraceLoginLimit, pwdLockout, pwdLockoutDuration, pwdMaxFailure, pwdFailureCountInterval, pwdMustChange, pwdAllowUserChange, and pwdSafeModify.

In this exemplary embodiment, pwdPolicy objectclass 603 contains two conditional clauses, conditional clause 608 and conditional clause 612. In conditional clause 608, the first set of attributes before colon 610 states: “pwdLockout is true.” The second set of attributes following colon 610 includes: pwdLockoutDuration, pwdMaxFailure, and pwdFailureCountInterval.

In evaluating conditional clause 608, if the value of attribute pwdLockout is set to true, the condition of the first set of attributes is evaluated as true and the second set of attributes: pwdLockoutDuration, pwdMaxFailure, and pwdFailureCountInterval all become “MUST” attributes for this entry. Thus, during an addition or modification to entry pwdPolicy, the entry will be checked to determine if pwdLockout is set to true. If pwdLockout is identified as being set to true, pwdLockoutDuration, pwdMaxFailure, and pwdFailureCountInterval must be present in the entry. If pwdLockout is identified as being set to true and if the pwdLockoutDuration, pwdMaxFailure, and pwdFailureCountInterval are not present in the entry, the addition or modification to the entry will fail in these examples.

Additionally, objectclass schema 602 contains conditional clause 612. In conditional clause 612, the first set of attributes before colon 614 is: “pwdCheckSyntax is not 0.” The second set of attributes following colon 614 includes pwdMinLength. Thus, during an addition or modification to a pwdPolicy entry, the entry will also be checked to determine if pwdCheckSyntax is not zero. If pwdCheckSyntax is identified to be not zero, pwdMinLength must be present in the entry, otherwise, the addition or modification to the entry will fail.

With reference to FIG. 7, another exemplary diagram of an objectclass schema is illustrated in accordance with an illustrative embodiment. Objectclass schema 702 defines the employee objectclass 704 illustrating conditional clause 706 wherein the first set of attributes includes more than one condition. In this exemplary embodiment, the “is [not] NULL|<value>” is specified as a string search filter. For example, the first set of attributes states (&(projectManager=abc)(projectID=*)). The “*” character is used as a wildcard character to match any value. The second set of attribute in the condition clause contains the attribute “userPassword”.

Thus, during an addition or modification to entry employee, the entry will be checked to determine if projectManager has value “abc” and projectID has any value. If projectManager has value “abc” and projectID has any value, userPassword must be present in the entry. If projectManager has value “abc” and projectID has any value and userPassword is not in the entry then the addition or modification to the entry will fail.

FIG. 8 is a flowchart illustrating a process for schema validation in accordance with an illustrative embodiment. The process in FIG. 8 may be implemented in a software component in a directory server, such as schema validation component 308 in directory server 300 in FIG. 3.

The process performs the schema validation for the entry as if the schema contained no conditional clauses (step 802). The validity of the entry is checked (step 804). For example, the entry is checked to identify that all the “MUST” attributes are present. If the entry is identified as being invalid, an objectclass violation error is returned (step 806) with the process terminating thereafter. If the entry is identified to be valid, then the validation component will perform a loop in which the validity of the conditional clauses will be checked for each objectclass in the entry (step 810).

The process will make a determination as to whether the objectclass contains conditional clauses (step 812). If the objectclass does not contain conditional clauses, the next objectclass will be processed (step 810). If the objectclass does contain conditional clauses at step 810, the validation component will determine if the condition is true (step 814). If the condition is not true, the next objectclass will be processed (step 810). If the condition is true at step 814, the validation component will determine if the conditional attributes are present (step 816). If the conditional attributes are not present, an objectclass violation error is returned with the process terminating thereafter (step 818). If the conditional attributes are present the next objectclass will be processed (step 810). If all objectclass entries have been processed and there has been no violation error, the schema validation component returns successfully with the process terminating thereafter (step 820).

Thus, an improved computer implemented method has been described above for defining a condition based schema for a directory on a directory server which substantially eliminates or reduces disadvantages and problems associated with previous systems and methods.

The illustrative embodiments described herein provide a computer implemented method, apparatus, and computer program product for defining a condition based schema for a directory on a directory server. A schema is defined based on a protocol for querying directory services on a directory server. A conditional statement is added to the schema. Responsive to a determination that a first set of attributes within the conditional statement is evaluated to be true, requiring a value for a second set of attributes within the schema to be present in an entry. The conditional statement is enforced by the server rather than by an application accessing the directory.

Accordingly, one embodiment of the invention shifts the responsibility of enforcing a conditional “MAY” or “MUST” attribute on the server rather than on the application accessing the directory. In turn, applications will be less complex and the directory will behave more naturally to real-world requirements. Attributes will be evaluated based on some relation and not by virtue of fact they belong to some objectclass.

Furthermore, the directory size can be reduced to a certain extent. Entries are loaded in memory caches whenever they are accessed so that the next operation on the same entry can be performed from cache, thus, leading to higher throughput. Moreover, if the entry size is reduced, more entries can be stored in the given limited memory area. Therefore, the present invention also contributes to the scalability of directory servers.

The flowchart and block diagrams in the figures illustrate the architecture, functionality, and operation of possible implementations of systems, methods and computer program products according to various embodiments. In this regard, each step in the flowchart or block diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for defining a condition base schema for a directory on a directory server, the method comprising:
defining the condition based schema using a protocol for querying directory services on a directory server;
adding a conditional statement to the schema;
responsive to a determination that a first set of attributes within the conditional statement is evaluated to be true, requiring a value for a second set of attributes within the schema to be present in an entry; and
enforcing the conditional statement by the server rather than by an application accessing the directory.

2. The computer implemented method of claim 1, wherein an attribute in the first set of attributes has a non NULL value.

3. The computer implemented method of claim 1, further comprising:
responsive to the first set of attributes within the conditional statement being evaluated as false, maintaining the value for the second set of attributes within the schema as optional.

4. The computer implemented method of claim 1, wherein the directory server is a lightweight directory access protocol (LDAP) directory server.

5. The computer implemented method of claim 1, wherein the directory server is an X.500 directory server.

6. A computer program product comprising:
a computer usable medium including computer usable program code for defining a condition based schema for a directory on a directory server, said computer program product comprising:
computer usable program code for defining the condition based schema using a protocol for querying directory services on a directory server;
computer usable program code for adding a conditional statement to the schema;
computer usable program code for requiring a value for a second set of attributes within the schema to be present in an entry in response to a determination that a first set of attributes within the conditional statement is evaluated to be true; and
computer usable program code for enforcing the conditional statement by the server rather than by an application accessing the directory.

7. The computer program product of claim 7, wherein an attribute in the first set of attributes has a non NULL value.

8. The computer program product of claim 7, further comprising:
computer usable program code for maintaining the value for the second set of attributes within the schema as optional in response to the first set of attributes within the conditional statement being evaluated as false.

9. The computer program product of claim 7, wherein the directory server is a lightweight directory access protocol (LDAP) directory server.

10. The computer program product of claim 7, wherein the directory server is an X.500 directory server.

11. An apparatus comprising:
a bus system;
a communications system connected to the bus system;
a memory connected to the bus system, wherein the memory includes computer usable program code; and
a processing unit connected to the bus system, wherein the processing unit executes the computer usable program code to define the condition based schema using a protocol for querying directory services on a directory server; add a conditional statement to the schema; require a value for a second set of attributes within the schema to be present in an entry in response to a determination that a first set of attributes within the conditional statement is evaluated to be true; and enforce the conditional statement by the server rather than by an application accessing the directory.

12. The apparatus of claim 11, wherein an attribute in the first set of attributes has a non NULL value.

13. The apparatus of claim 11, further comprising:
responsive to the first set of attributes within the conditional statement being evaluated as false, maintaining the value for the second set of attributes within the schema as optional.

14. The apparatus of claim 11, wherein the directory server is a lightweight directory access protocol (LDAP) directory server.

15. The apparatus of claim 11, wherein the directory server is an X.500 directory server.
